(19) United States
(12) Patent Application Publication
(10) Pub. No.: US 2026/0158802 A1
(43) Pub. Date: Jun. 11, 2026

(54) PRINT CONTROL APPARATUS, PRINT CONTROL METHOD, AND STORAGE MEDIUM

(71) Applicant: CANON KABUSHIKI KAISHA, Tokyo (JP)

(72) Inventor: TAKASHI SAWADA, Saitama (JP)

(21) Appl. No.: 19/179,615

(22) Filed: Apr. 15, 2025

(30) Foreign Application Priority Data
Apr. 18, 2024 (JP) 2024-067484

(51) Int. Cl. B41J 13/00; B41J 13/10; B41J 29/46

(52) U.S. Cl. CPC B41J 13/0018; B41J 13/103; B41J 29/46

(57) ABSTRACT

A print control apparatus includes a first feed unit configured to interfere with paper conveyance in a conveyance path from another feed unit when paper loading, a second feed unit configured to not interfere with the paper conveyance in the conveyance path from the another feed unit when paper loading, the second feed unit being provided with a conveyance path configured to not be interfered with when paper loading in the another feed unit, and at least one memory and at least one processor configured to switch from a first state in which paper is fed from the first feed unit to a second state in which paper is fed from the second feed unit in response to the first feed unit running out of paper, and perform control to make a notification for prompting a user to refill the first feed unit with paper in the second state.

### BACKGROUND

### Field of the Disclosure

The present disclosure relates to a print control apparatus, a print control method, and a storage medium.

### Description of the Related Art

In printing apparatuses with a plurality of paper feed trays, there has been a known automatic switching technique in which with identical sheets set in the plurality of paper feed trays, when one of the paper feed trays runs out of sheets, sheets are automatically fed from another tray to prevent interruption of a job due to a paper-out condition during printing. Examples of the technique include controls of switching between cassettes and a manual feed unit, from a cassette 1 to a cassette 2, and from a cassette 2 to the manual feed unit. Japanese Patent Application Laid-Open No. 2011-148629 discusses a printing apparatus in which with conveyance paths from paper feed trays passing the uppermost paper feed tray, when a plurality of paper feed trays are capable of feeding, sheets are fed preferentially from the lowermost paper feed tray.

In the technique discussed in Japanese Patent Application Laid-Open No. 2011-148629, when a job involving a large volume of printing is input to, for example, a printing apparatus with two paper feed trays, sheets are fed from the lower paper feed tray first. Once the lower paper feed tray runs out of sheets, the paper feed slot is switched to the upper paper feed tray. While sheets are fed from the upper paper feed tray, the lower paper feed tray then can be refilled with sheets. However, when the paper feed slot is switched back to the lower paper feed tray, the upper paper feed tray cannot be refilled with sheets while sheets are being fed from the lower paper feed tray. Thus, the job will be interrupted due to a paper-out condition.

### SUMMARY

Embodiments of the present disclosure are directed to preventing interruption of printing due to a paper-out condition.

According to an aspect of the present disclosure, a print control apparatus includes a first paper feed unit configured to interfere with paper conveyance in a conveyance path from another paper feed unit in a case where paper is being loaded in the first paper feed unit, a second paper feed unit configured to not interfere with the paper conveyance in the conveyance path from the another paper feed unit in a case where paper is being loaded in the second paper feed unit, the second paper feed unit being provided with a conveyance path configured to not be interfered with in a case where paper is being loaded in the another paper feed unit, and at least one memory and at least one processor configured to, during printing of a plurality of sheets of paper, switch from a first state in which paper is fed from the first paper feed unit to a second state in which paper is fed from the second paper feed unit in response to the first paper feed unit running out of the paper, and perform control to make a notification for prompting a user to refill the first paper feed unit with paper in the second state.

Further features of various embodiments will become apparent from the following description of exemplary embodiments with reference to the attached drawings.

### BRIEF DESCRIPTION OF THE DRAWINGS

FIG. 1 is a schematic view of an internal configuration of a printing apparatus.

FIG. 2 is a block diagram illustrating a hardware configuration of the printing apparatus.

FIG. 3 illustrates a state in which an upper cassette is pulled during paper feeding from the lower cassette.

FIG. 4 is a flowchart illustrating a control process of switching paper feed slots during execution of a print job.

FIG. 5 is a diagram illustrating a display example of a first notification screen.

FIG. 6 is a diagram illustrating a display example of a second notification screen.

FIG. 7 is a diagram illustrating a display example of the second notification screen.

### DESCRIPTION OF THE EMBODIMENTS

Some exemplary embodiments of the present disclosure will now be described with reference to the drawings.

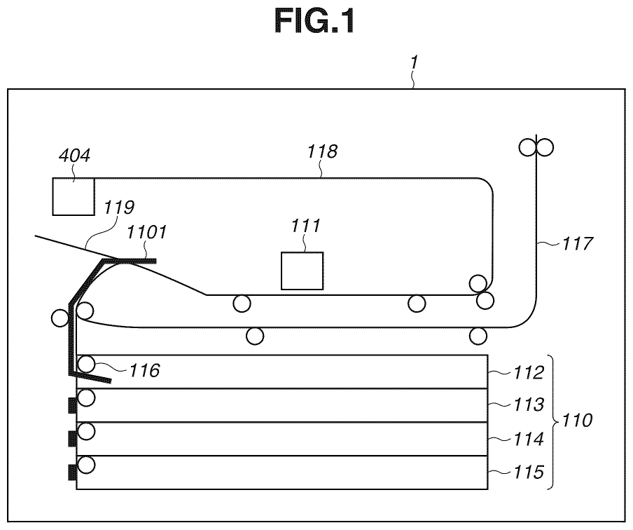

FIG. 1 is a schematic view of an internal configuration of a printing apparatus according to an exemplary embodiment as seen from a side. In the printing apparatus 1 illustrated in FIG. 1, the front corresponds to the left, and the rear corresponds to the right. In horizontal directions of the printing apparatus 1 illustrated in FIG. 1, the leftward direction is the forward direction, and the rightward direction is the rearward direction. The printing apparatus 1 illustrated in FIG. 1 includes an inkjet printing unit. However, the printing method is not limited to an inkjet method, and other printing methods, such as the electrophotographic method, can be used. In addition to the printing unit, the printing apparatus 1 can include other functional units, such as a scanner unit.

The printing apparatus 1 includes a paper feed cassette 110 that holds sheets to be fed. The paper feed cassette 110 includes a first cassette 112, a second cassette 113, a third cassette 114, and a fourth cassette 115 that are stacked vertically. The first cassette 112 is arranged at the top. The fourth cassette 115 is arranged at the bottom. Each cassette of the paper feed cassette 110 is accommodated in the main body of the printing apparatus 1, and is pulled forward from the front of the printing apparatus 1 for loading or replacing sheets. In the present exemplary embodiment, the paper feed cassette 110 is composed of four cassettes, but the number of cassettes is not necessarily four as long as the number of cassettes is two or more.

The printing apparatus 1 feeds sheets from the paper feed cassette 110. The fed sheets are conveyed from a paper feed position to a printing position along a paper feed path. At the printing position, the printing apparatus 1 performs recording based on image data using a print head 111 to print on the sheets. The sheets subjected to the recording operation at the printing position are conveyed to a paper discharge port 118.

The printing apparatus 1 includes a manual feed tray 119 that holds paper to be fed. The manual feed tray 119 is exposed to the outside of the main body of the printing apparatus 1, and sheets are placed thereon. Thus, the manual feed tray 119 is capable of paper loading and replacement without being pulled from the main body of the printing apparatus 1. The printing apparatus 1 can also feed sheets from the manual feed tray 119. The sheets fed from the manual feed tray 119 are conveyed to the printing position along a paper feed path. The sheets subjected to a recording operation at the printing position are conveyed to the paper discharge port 118.

The printing apparatus 1 includes a plurality of conveyance rollers for conveying paper from a paper feed position to the paper discharge port 118. Elements depicted as circles in FIG. 1 represent the conveyance rollers. A conveyance roller 116 is used to take sheets from the first cassette 112. A reverse path 117 is used for double-sided printing. The printing apparatus 1 uses the reverse path 117 to reverse sheets and print on both sides of the sheets.

When printing is started with sheets loaded in the first cassette 112 and the first cassette 112 is selected as the paper feed slot to be used for a paper feeding, the printing apparatus 1 uses the conveyance roller 116 attached to the first cassette 112 to take sheets one by one. A sheet 1101 is conveyed to the printing position along the paper feed path. The sheet 1101 subjected to the recording operation at the printing position is discharged facedown (in a state where a side with the image formed thereon is facing downward) from the paper discharge port 118.

An operation panel 404 is, for example, a touch panel, and is provided on the front of the printing apparatus 1. The operation panel 404 displays a user interface (UI) screen that receives input operations from a user, and information to be notified to the user.

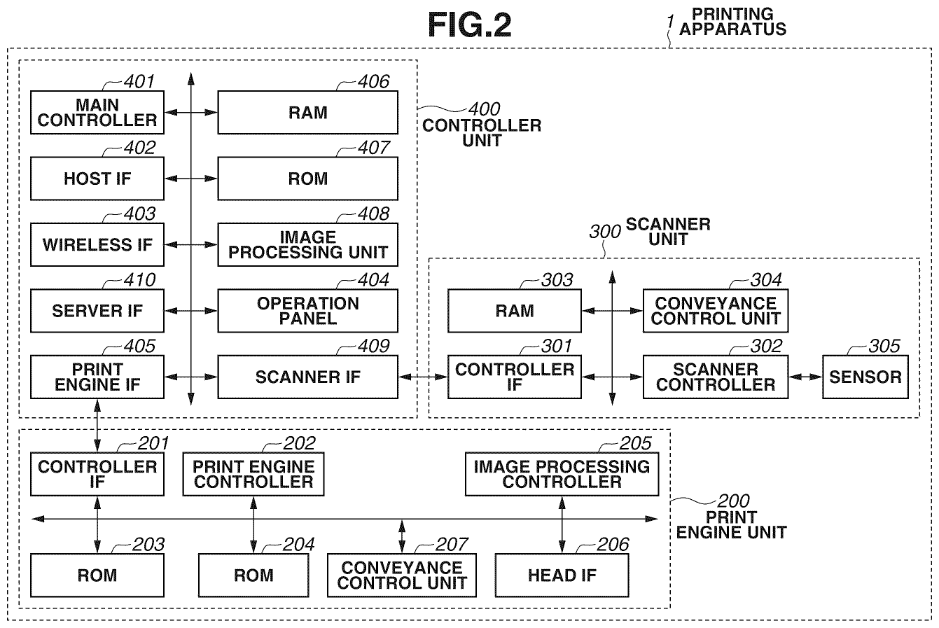

FIG. 2 is a block diagram illustrating a hardware configuration of the printing apparatus 1. The printing apparatus 1 includes a print engine unit 200 as a printing unit, a scanner unit 300 as a scanning unit, and a controller unit 400 that generally controls the printing apparatus 1. The printing apparatus 1 is an example of a print control apparatus.

The controller unit 400 will now be described.

The controller unit 400 includes a main controller 401, a random-access memory (RAM) 406, a read-only memory (ROM) 407, an image processing unit 408, and an operation panel 404. The controller unit 400 also includes a host interface (a host IF) 402, a wireless interface (a wireless IF) 403, and a server interface (a server IF) 410.

The host IF 402, the wireless IF 403, and the server IF 410 are used for transmitting and receiving data to and from a communicable external device or server device via wired or wireless communications. The external device is, for example, a personal computer (PC) or a smartphone on which a dedicated application for the printing apparatus 1 is installed. The external device has a function of starting the dedicated application to generate a print job as print data for printing image data using the printing apparatus 1, and the external device has a function of transmitting the print job and the print instruction to the printing apparatus 1. The external device also has a function of receiving, from the printing apparatus 1, information about a status of the printing apparatus 1. The main controller 401 receives print jobs and print instructions from the external device and transmits information about statuses of the printing apparatus 1 to the external device via the host IF 402.

A print engine interface (a print engine IF) 405 is connected to a controller interface (a controller IF) 201 of the print engine unit 200 to exchange data including various commands with the print engine unit 200. The print engine unit 200 controls the mechanisms of the print engine unit 200 in response to instructions from the main controller 401.

A scanner interface (a scanner IF) 409 is connected to the controller IF 301 of the scanner unit 300 to exchange data with the scanner unit 300. The scanner unit 300 controls the mechanisms of the scanner unit 300 in response to instructions from the main controller 401.

The main controller 401 includes a central processing unit (CPU) and generally controls the printing apparatus 1. The RAM 406 temporarily stores various types of data. The ROM 407 stores various programs and various types of data. The main controller 401 uses the RAM 406 as a working memory to run the various programs stored in the ROM 407.

The operation panel 404 is, for example, a touch panel that can display characters, figures, and indicators. The main controller 401 controls the display details on the operation panel 404. The operation panel 404 displays a copy screen for instructing a copy operation, a setting screen for making various settings, such as a print mode, and a notification screen for notifying a status of the printing apparatus 1. The operation panel 404 can include switches and/or hard keys for the user to perform input operations.

An image processing unit 408 performs predetermined image processing on image data included in print jobs input via the host IF 402 based on instructions from the main controller 401.

The main controller 401 transmits the image data subjected to the image processing to the print engine unit 200 via the print engine IF 405.

The print engine unit 200 will now be described.

The print engine unit 200 includes the controller IF 201, a print engine controller 202, a ROM 203, a RAM 204, an image processing controller 205, a head interface (a head IF) 206, and a conveyance control unit 207. The print engine controller 202, which includes a CPU, controls the mechanisms of the print engine unit 200 based on programs and parameters stored in the ROM 203 using the RAM 204 as a working area.

The controller IF 201 is connected to the print engine IF 405 of the controller unit 400 to exchange data between the print engine unit 200 and the controller unit 400. Upon receipt of various commands and image data from the controller unit 400 via the controller IF 201, the print engine controller 202 temporarily stores the commands and the image data in the RAM 204.

The print engine controller 202 controls the image processing controller 205 to generate recording data from the image data stored in the RAM 204. When recording data is generated, the print engine controller 202 performs a recording operation based on the recording data using the print head 111 via the head IF 206 under the control of the main controller 401.

At this time, under the control of the main controller 401, the print engine controller 202 drives conveyance rollers illustrated in FIG. 1 via the conveyance control unit 207 to convey sheets. In this manner, the printing process is performed by synchronizing the recoding operation of the print head 111 with the conveyance of sheets.

The ROM 203 stores setting values of various parameters, such as N-in-1 printing (N is an integer), double-sided printing or single-sided printing, full-color printing or monochrome printing, and photo printing or document printing. If parameters are to be set by each user, the main controller 401 can input setting values from the operation panel 404 to the print engine unit 200 via the print engine IF 405, and the main controller 401 can reflect the setting values in the print settings.

The scanner unit 300 will now be described.

The scanner unit 300 includes a controller interface (a controller IF) 301, a scanner controller 302, a RAM 303, a conveyance control unit 304, and a sensor 305. The controller IF 301 is connected to the scanner IF 409 of the controller unit 400 to exchange data between the scanner unit 300 and the controller unit 400. The scanner controller 302 receives various commands from the controller unit 400 via the controller IF 301. The scanner controller 302 conveys documents placed on an automatic document feeder (ADF) by the user via the conveyance control unit 304, reads the documents using the sensor 305, and saves the read image data in the RAM 303. The print engine controller 202 can also convert the read image data into recording data to perform the recording operation using the print head 111 based on the recording data under the control of the main controller 401.

### Automatic Paper Feed Slot Switching Function

The printing apparatus 1 according to the present exemplary embodiment has a function of switching between paper feed slots without an instruction from the user (hereinafter, referred to as an automatic paper feed slot switching function). In the present exemplary embodiment, the paper feed slots refer to the paper feed cassette 110 (the first cassette 112, the second cassette 113, the third cassette 114, and the fourth cassette 115) and the manual feed tray 119. If sheets are loaded in the paper feed slots, the automatic paper feed slot switching function makes it possible to select an appropriate paper feed slot depending on the paper size, the paper type, and the print job type and to switch between the paper feed slots.

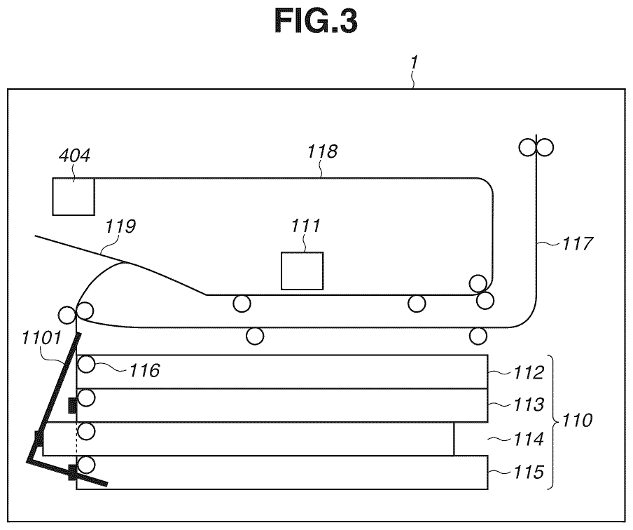

FIG. 3 illustrates a state where an upper cassette is pulled forward while a lower cassette is being used for paper feeding. FIG. 3 illustrates a state where the third cassette 114, which is arranged directly above the fourth cassette 115, is pulled while the fourth cassette 115 is being used for a paper feeding. As illustrated in FIG. 3, the conveyance path of the sheet 1101 fed from the fourth cassette 115 passes the front of the third cassette 114. When the third cassette 114 is pulled forward, the conveyance path is blocked by the third cassette 114, which causes a paper jam. In other words, when sheets are loaded in a cassette, the conveyance of sheets from another cassette below the cassette is blocked. Thus, loading sheets in a cassette above the cassette being used for the paper feeding cannot be performed.

On the other hand, when sheets are being loaded in the manual feed tray 119, the sheet conveyance from the paper feed cassette 110 is not blocked. Furthermore, when sheets are being loaded in the paper feed cassette 110, the paper conveyance from the manual feed tray 119 is not blocked. Thus, the manual feed tray 119 can be refilled with sheets while the paper feed cassette 110 is being used for a paper feeding, and the paper feed cassette 110 can be refilled with sheets while the manual feed tray 119 is being used for a paper feeding.

The following is a description of switching control between the cassettes to be used for a paper feeding when the same type of sheets is loaded in the cassettes. In this case, if an upper cassette is used preferentially over the lower cassette(s), the upper cassette will run out of sheets first. The paper feed slot is then switched from the upper cassette to a lower cassette, and the upper cassette cannot be refilled with sheets while the lower cassette is being used for the paper feeding. On the other hand, if the lower cassette is used preferentially over the upper cassette(s), the lower cassette runs out of paper first, and the paper feed slot is then switched from the lower cassette to an upper cassette. The lower cassette can be refilled with paper while the upper cassette is being used for the paper feeding.

Thus, in the automatic paper feed slot switching function of the present exemplary embodiment, the fourth cassette 115, the third cassette 114, the second cassette 113, and the first cassette 112 are selected in this order so that the lowest cassette is used preferentially over the upper cassettes, and the manual feed tray 119 is selected last. In other words, from the highest priority, the order for switching the paper feed slots is as follows: the fourth cassette 115, the third cassette 114, the second cassette 113, the first cassette 112, and the manual feed tray 119.

### Control Process of Switching Paper Feed Slots

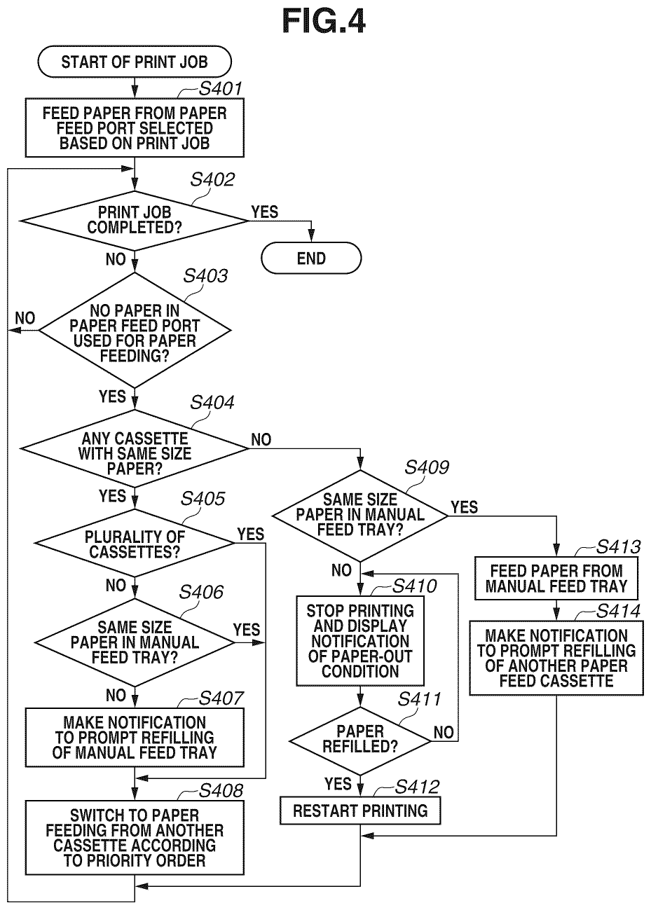

FIG. 4 is a flowchart illustrating a procedure of a control process of switching paper feed slots during the execution of a print job.

The process of the flowchart illustrated in FIG. 4 is performed by the main controller 401 loading programs from the ROM 407 into the RAM 406 and running the programs. The process of the flowchart illustrated in FIG. 4 is performed in response to the start of a print job involving printing a plurality of sheets.

In step S401, when a print job is started, the main controller 401 selects a paper feed slot (the first cassette 112, the second cassette 113, the third cassette 114, the fourth cassette 115, or the manual feed tray 119) based on settings of the print job to feed sheets. Since an appropriate paper feed slot differs depending on the sheet size and the sheet type, any paper feed slot can be selected. The main controller 401 performs a printing process by performing a recording operation on the fed sheets using the print head 111 based on the print job.

In step S402, the main controller 401 determines whether the print job is completed. If the print job is completed (YES in step S402), the process of the flowchart ends. If the print job is continued (NO in step S402), the process proceeds to step S403.

In step S403, the main controller 401 determines whether sheets exist in the paper feed slot being used for the paper feeding. For example, the paper feed cassette 110 can be provided with remaining number detection sensors that detects numbers of sheets stored therein. The main controller 401 can determine whether sheets exist based on a value of the remaining number detection sensor in the cassette being used for the paper feeding. If sheets exist (NO in step S403), the process proceeds to step S402, and if no sheets exist (YES in step S403), the process proceeds to step S404.

In step S404, the main controller 401 determines whether a cassette loaded with sheets of the same size as those in the paper feed slot being used for the paper feeding exists. While sheets of the same size are specified here, sheets of the same type can be used. If a cassette loaded with sheets of the size exists (YES in step S404), the process proceeds to step S405. If no other cassettes loaded with sheets of the same size exist (NO in step S404), the process proceeds to step S409.

In step S405, the main controller 401 determines whether a plurality of cassettes with sheets of the same size as those in the paper feed slot being used for the paper feeding exists. If the plurality of cassettes exists (YES in step S405), the process proceeds to step S408. If the plurality of cassettes does not exist (NO in step S405), the process proceeds to step S406.

In step S406, the main controller 401 determines whether sheets of the same size as those in the paper feed slot being used for the paper feeding are loaded into the manual feed tray 119. If sheets of the same size are loaded into the manual feed tray 119 (YES in step S406), the process proceeds to step S408. If not (NO in step S406), the process proceeds to step S407.

In step S407, the main controller 401 makes a notification for prompting the user to refill the manual feed tray 119 with sheets. In the present exemplary embodiment, a first notification screen including a message prompting the user to refill the manual feed tray 119 with sheets is displayed on the operation panel 404. The main controller 401 may make the notification by voice using a speaker (not illustrated). The main controller 401 may also perform control to display the first notification screen on a display unit of an external device, such as a smartphone, that has transmitted the print job or the print instruction to the printing apparatus 1 via the wireless IF 403.

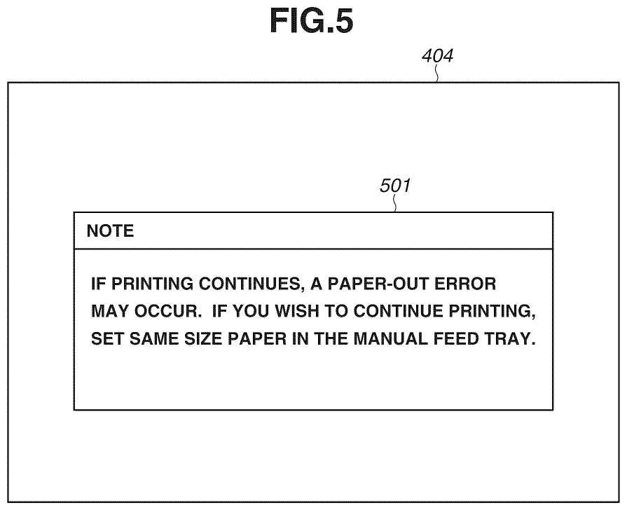

FIG. 5 illustrates an example of the first notification screen displayed on the operation panel 404. The first notification screen 501 displays a message prompting the user to load sheets of the same size as those being fed into the manual feed tray 119. The first notification screen 501 may not be continuously displayed on the operation panel 404 during a printing, but may be displayed as a pop-up for a certain period of time, or may be hidden when the operation panel 404 is touched.

For example, when a print job is started, the fourth cassette 115 is selected to start a paper feeding. If the fourth cassette 115 runs out of sheets and sheets of the same size are loaded in the third cassette 114 alone, the paper feed slot is switched to the third cassette 114.

When the paper feed slot is switched to the third cassette 114, sheets of the same size as those in the third cassette 114 are not loaded in any other cassettes or into the manual feed tray 119. In this state, the main controller 401 displays the first notification screen on the operation panel 404 to prompt the user to refill the manual feed tray 119 with sheets.

As described above, the manual feed tray 119 does not interfere with the conveyance of sheets from the paper feed cassette 110, so that the manual feed tray 119 can be refilled with sheets even during a paper feeding from the paper feed cassette 110.

In step S408, in accordance with the priority order for the automatic paper feed slot switching function, the main controller 401 switches the paper feeding slot to a cassette in the paper feed cassette 110 other than the cassette that is currently being used for the paper feeding, or the main controller 401 switches the paper feeding slot to the manual feed tray 119. This continues the printing process.

In step S409, the main controller 401 determines whether sheets of the same size as those in the paper feed slot being used for the paper feeding are loaded into the manual feed tray 119. If sheets of the same size are loaded (YES in step S409), the process proceeds to step S413. If not (NO in step S409), the process proceeds to step S410.

In step S410, the main controller 401 determines that no paper feed slots exist from which sheets can be fed, stops the printing process, and displays a notification indicating a paper-out condition on the operation panel 404.

In step S411, the main controller 401 determines whether the paper feed cassette 110 or the manual feed tray 119 is refilled with sheets of the same size as those in the paper feed slot being used for the paper feeding. The process waits in step S410 until the paper feed cassette 110 or the manual feed tray 119 is refilled with sheets. If the paper feed cassette 110 or the manual feed tray 119 is refilled with sheets (YES in step S411), the process proceeds to step S412.

In step S412, the main controller 401 restarts the printing process by starting paper feeding from the manual feed tray 119.

In step S413, the main controller 401 switches the paper feed slot to the manual feed tray 119. This continues the printing process. Here, it is on the assumption that the main controller 401 switches the paper feed slot from the first cassette 112 to the manual feed tray 119 in response to a run-out of sheets in the first cassette 112 while sheets are being fed therefrom. This allows sheets to be fed from the manual feed tray 119. The first cassette 112 is an example of a first paper feed unit. The manual feed tray 119 is an example of a second paper feed unit.

In step S414, the main controller 401 makes a notification for prompting the user to refill the paper feed cassette 110 with sheets while sheets are being fed from the manual feed tray 119. In the present exemplary embodiment, a second notification screen including a message prompting the user to refill the paper feed cassette 110 with sheets is displayed on the operation panel 404. As described above, the paper conveyance path from the manual feed tray 119 is not blocked while sheets are being loaded in the paper feed cassette 110, so that the paper feed cassette 110 can be refilled with sheets even when sheets are being fed from the manual feed tray 119. The main controller 401 may compare the remaining number of sheets stacked in the manual feed tray 119 with the number of sheets predicted to be used for an ongoing print job, and perform control so as not to make a notification if the remaining number of paper sheets is greater than the predicted number.

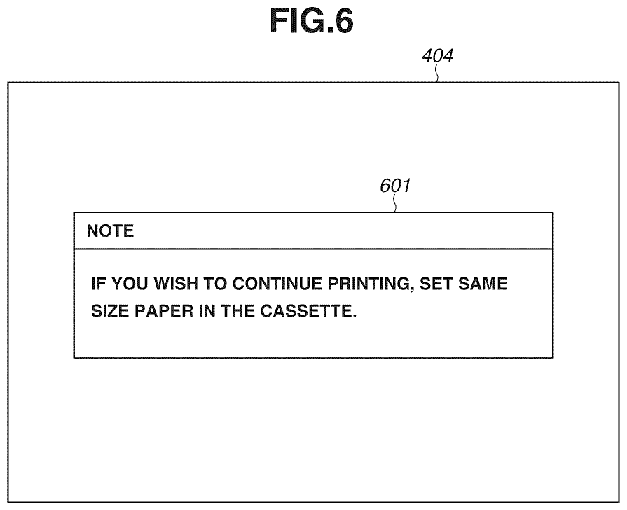

FIG. 6 illustrates an example of the second notification screen displayed on the operation panel 404 while sheets are being fed from the manual feed tray 119. A second notification screen 601 displays a message prompting the user to load sheets of the same size as those being fed in the paper feed cassette 110. The main controller 401 may make the notification by voice using a speaker (not illustrated). The main controller 401 may also perform control to display the second notification screen on a display unit of an external device, such as a smartphone, that has transmitted the print job or the print instruction to the printing apparatus 1 via the wireless IF 403.

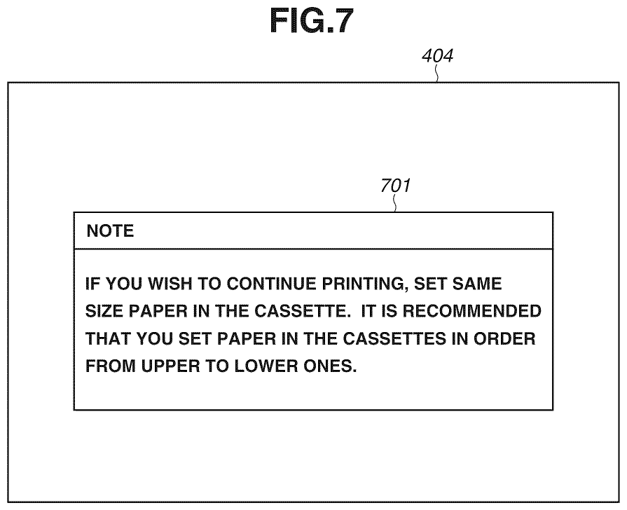

FIG. 7 illustrates another example of the second notification screen displayed on the operation panel 404 while sheets are being fed from the manual feed tray 119. A second notification screen 701 is displayed on the operation panel 404 in the same manner as that of the second notification screen 601. In the present exemplary embodiment, a lower cassette has a higher priority in switching between the paper feed slots, so that sheets are fed from a lower cassette prior to an upper cassette. While sheets are being fed from a lower cassette, loading sheets in an upper cassette will block the paper conveyance from the lower cassette, which prevents sheets from being loaded into the upper cassette. Thus, a message is displayed on the second notification screen 701 for prompting the user to load sheets in the cassettes in the order from the uppermost to the lowermost ones.

According to the present exemplary embodiment, in loading sheets, the user can be prompted to refill the paper feed cassette 110 with sheets while sheets are being fed from the manual feed tray 119 that does not block the paper conveyance path from the paper feed cassette 110. This can prevent interruption of printing since the cassette is refilled with sheets while sheets are being fed from the manual feed tray.

The controls that have been described above as being performed by the main controller 401 can be performed by a piece of hardware, or the entire apparatus can be controlled by a plurality of pieces of hardware (for example, a plurality of processors or circuits) sharing processing. The present disclosure has described an exemplary embodiment in detail, but some embodiments are not limited to the exemplary embodiment. Various forms are also included in the present disclosure without departing from the gist of the present disclosure. Furthermore, the above-described exemplary embodiment is merely an exemplary embodiment of the present disclosure, and those exemplary embodiments can be combined as appropriate.

In the above-described exemplary embodiment, various notifications are controlled by the main controller 401 of the printing apparatus 1. However, various notifications can be controlled by the CPU of an external device (such as a PC or a smartphone) on which dedicated application software (such as a printer driver) is installed for the printing apparatus 1. In this case, the printing apparatus 1 can transmit and receive data to and from the external device, and share information about states of the sheets loaded in each paper feed slot and information about the paper feed slot being used for a paper feeding with the external device. For example, when the external device detects, based on the information received from the printing apparatus 1, that the first cassette 112 is out of paper and the printing apparatus 1 then switches the paper feeding slot to the manual feed tray 119, the printing apparatus 1 can control the display unit of the external device to display the first notification screen.

### Other Exemplary Embodiments

Embodiments of the present disclosure can also be implemented by a process in which a program for carrying out one or more of the functions of the above-described exemplary embodiment is supplied to a system or an apparatus via a network or a storage medium, and one or more processors in a computer of the system or apparatus read and execute the program. Embodiments of the present disclosure can also be implemented by a circuit (for example, an application specific integrated circuit (ASIC)) that carries out one or more of the functions.

The disclosure of the above-described exemplary embodiments includes the following configurations, methods, programs, and storage media.

### Configuration 1

A print control apparatus for controlling a printing apparatus, the print control apparatus comprising: a first paper feed unit configured to interfere with paper conveyance in a conveyance path from another paper feed unit in a case where paper is being loaded in the first paper feed unit; a second paper feed unit configured to not interfere with the paper conveyance in the conveyance path from the another paper feed unit in a case where paper is being loaded in the second paper feed unit, the second paper feed unit being provided with a conveyance path configured to not be interfered with in a case where paper is being loaded in the another paper feed unit; and at least one memory and at least one processor configured to, during printing of a plurality of sheets of paper, switch from a first state in which paper is fed from the first paper feed unit to a second state in which paper is fed from the second paper feed unit in response to the first paper feed unit running out of the paper, and perform control to make a notification for prompting a user to refill the first paper feed unit with paper in the second state.

### Configuration 2

The print control apparatus according to configuration 1, wherein the second paper feed unit is a paper feed unit that is loaded with paper while being exposed to outside of a main body of the print control apparatus, a paper feed unit capable of being refilled with paper without a mechanical change, or a manual paper feed unit.

### Configuration 3

The print control apparatus according to configuration 1 or 2, the at least one memory and at least one processor are further configured to, when the first paper feed unit is out of paper, and paper of the same type as that loaded in the first paper feed unit is loaded in the second paper feed unit and in a third paper feed unit other than the first and second paper feed units, switch to a state in which the paper is fed from the third paper feed unit with higher priority than the second paper feed unit.

### Configuration 4

The print control apparatus according to configuration 3, wherein the at least one memory and at least one processor are further configured to, in a case where a plurality of paper feed units exists in which paper of the same type as that loaded in the first paper feed unit is loaded, prioritize a paper feed unit having a longer conveyance path than other paper feed units, the conveyance path passing from a paper feed position to a printing position where printing is performed on the paper conveyed from the paper feed position.

### Configuration 5

The print control apparatus according to any one of configurations 1 to 4, wherein the at least one memory and at least one processor are further configured to, in a case where paper of the same type as that loaded in the first paper feed unit is not loaded in any paper feed units other than the first and second paper feed units or in the second paper feed unit, make a notification for prompting the user to set the paper of the same type in the second paper feed unit.

### Configuration 6

The print control apparatus according to any one of configurations 1 to 5, wherein the at least one memory and at least one processor are further configured to, in the second state, perform control to make a notification for prompting the user to refill the first paper feed unit with paper prior to a paper feed unit or paper feed units other than the first and second paper feed units.

### Configuration 7

The print control apparatus according to any one of configurations 1 to 6, wherein the first paper feed unit is a cassette accommodated in a main body of the print control apparatus, and in a case where the first paper feed unit is pulled from the main body for paper loading, the first paper feed unit interferes with paper conveyance in a conveyance path from a cassette accommodated below the first paper feed unit.

### Configuration 8

The print control apparatus according to any one of configurations 1 to 7, wherein the at least one memory and the at least one processor are further configured to, during printing, receive information about a paper feed unit being used for paper feeding and paper loaded in each paper feed unit, and, upon detection of switching from the first state to the second state in response to the first paper feeding unit running out of the paper, based on the information received, perform control to make a notification for prompting the user to refill the first paper feeding unit with paper in the second state.

### Configuration 9

The print control apparatus according to configuration 8, wherein a printer driver is installed on the print control apparatus.

### Method

A print control method for controlling a printing apparatus including a first paper feed unit configured to interfere with paper conveyance in a conveyance path from another paper feed unit in a case where paper is being loaded in the first paper feed unit, a second paper feed unit configured to not interfere with the paper conveyance in the conveyance path from the another paper feed unit in a case where paper is being loaded in the second paper feed unit, the second paper feed unit being provided with a conveyance path configured to not be interfered with in a case where paper is being loaded in the another paper feed unit, the print control method comprising during printing of a plurality of sheets of paper, switching from a first state in which paper is fed from the first paper feed unit to a second state in which paper is fed from the second paper feed unit in response to the first paper feed unit running out of the paper, and performing control to make a notification for prompting a user to refill the first paper feed unit with paper in the second state.

### Program

A program for causing a computer to function as each unit of the print control apparatus according to any one of configurations 1 to 9.

### Storage Medium

A non-transitory computer-readable storage medium storing computer-executable instructions for causing a computer to perform a print control method for controlling a printing apparatus including a first paper feed unit configured to interfere with paper conveyance in a conveyance path from another paper feed unit in a case where paper is being loaded in the first paper feed unit, a second paper feed unit configured to not interfere with the paper conveyance in the conveyance path from the another paper feed unit in a case where paper is being loaded in the second paper feed unit, the second paper feed unit being provided with a conveyance path configured to not be interfered with in a case where paper is being loaded in the another paper feed unit, the print control method comprising during printing of a plurality of sheets of paper, switching from a first state in which paper is fed from the first paper feed unit to a second state in which paper is fed from the second paper feed unit in response to the first paper feed unit running out of the paper, and performing control to make a notification for prompting a user to refill the first paper feed unit with paper in the second state.

According to the present disclosure, interruption of printing due to a paper-out condition can be prevented.

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-067484, which was filed on Apr. 18, 2024 and which is hereby incorporated by reference herein in its entirety.

What is claimed is:

1. A print control apparatus comprising:
a first paper feed unit configured to interfere with paper conveyance in a conveyance path from another paper feed unit in a case where paper is being loaded in the first paper feed unit;
a second paper feed unit configured to not interfere with the paper conveyance in the conveyance path from the another paper feed unit in a case where paper is being loaded in the second paper feed unit, the second paper feed unit being provided with a conveyance path configured to not be interfered with in a case where paper is being loaded in the another paper feed unit; and
at least one memory and at least one processor configured to:
during printing of a plurality of sheets of paper, switch from a first state in which paper is fed from the first paper feed unit to a second state in which paper is fed from the second paper feed unit in response to the first paper feed unit running out of the paper; and
perform control to make a notification for prompting a user to refill the first paper feed unit with paper in the second state.

2. The print control apparatus according to claim 1, wherein the second paper feed unit is a paper feed unit that is loaded with paper while being exposed to outside of a main body of the print control apparatus, a paper feed unit capable of being refilled with paper without a mechanical change, or a manual paper feed unit.

3. The print control apparatus according to claim 1, wherein the at least one memory and at least one processor are further configured to, when the first paper feed unit is out of paper, and paper of the same type as that loaded in the first paper feed unit is loaded in the second paper feed unit and in a third paper feed unit other than the first and second paper feed units, switch to a state in which the paper is fed from the third paper feed unit with higher priority than the second paper feed unit.

4. The print control apparatus according to claim 3, wherein the at least one memory and at least one processor are further configured to, in a case where a plurality of paper feed units exists in which paper of the same type as that loaded in the first paper feed unit is loaded, prioritize a paper feed unit having a longer conveyance path than other paper feed units, the conveyance path passing from a paper feed position to a printing position where printing is performed on the paper conveyed from the paper feed position.

5. The print control apparatus according to claim 1, wherein the at least one memory and at least one processor are further configured to, in a case where paper of the same type as that loaded in the first paper feed unit is not loaded in any paper feed units other than the first and second paper feed units or in the second paper feed unit, make a notification for prompting the user to set the paper of the same type in the second paper feed unit.

6. The print control apparatus according to claim 1, wherein the at least one memory and at least one processor are further configured to, in the second state, perform control to make a notification for prompting the user to refill the first paper feed unit with paper prior to a paper feed unit or paper feed units other than the first and second paper feed units.

7. The print control apparatus according to claim 1, wherein the first paper feed unit is a cassette accommodated in a main body of the print control apparatus, and in a case where the first paper feed unit is pulled from the main body for paper loading, the first paper feed unit interferes with paper conveyance in a conveyance path from a cassette accommodated below the first paper feed unit.

8. The print control apparatus according to claim 1, wherein the at least one memory and the at least one processor are further configured to:
during printing, receive information about a paper feed unit being used for paper feeding and paper loaded in each paper feed unit; and
upon detection of switching from the first state to the second state in response to the first paper feeding unit running out of the paper, based on the information received, perform control to make a notification for prompting the user to refill the first paper feeding unit with paper in the second state.

9. The print control apparatus according to claim 8, wherein a printer driver is installed on the print control apparatus.

10. A print control method for controlling a printing apparatus including a first paper feed unit configured to interfere with paper conveyance in a conveyance path from another paper feed unit in a case where paper is being loaded in the first paper feed unit, a second paper feed unit configured to not interfere with the paper conveyance in the conveyance path from the another paper feed unit in a case where paper is being loaded in the second paper feed unit, the second paper feed unit being provided with a conveyance path configured to not be interfered with in a case where paper is being loaded in the another paper feed unit, the print control method comprising:
during printing of a plurality of sheets of paper, switching from a first state in which paper is fed from the first paper feed unit to a second state in which paper is fed from the second paper feed unit in response to the first paper feed unit running out of the paper; and
performing control to make a notification for prompting a user to refill the first paper feed unit with paper in the second state.

11. A non-transitory computer-readable storage medium storing computer-executable instructions for causing a computer to perform a print control method for controlling a printing apparatus including a first paper feed unit configured to interfere with paper conveyance in a conveyance path from another paper feed unit in a case where paper is being loaded in the first paper feed unit, a second paper feed unit configured to not interfere with the paper conveyance in the conveyance path from the another paper feed unit in a case where paper is being loaded in the second paper feed unit, the second paper feed unit being provided with a conveyance path configured to not be interfered with in a case where paper is being loaded in the another paper feed unit, the print control method comprising:
during printing of a plurality of sheets of paper, switching from a first state in which paper is fed from the first paper feed unit to a second state in which paper is fed from the second paper feed unit in response to the first paper feed unit running out of the paper; and
performing control to make a notification for prompting a user to refill the first paper feed unit with paper in the second state.
